(19) United States
(12) Patent Application Publication
(10) Pub. No.: US 2007/0156758 A1
(43) Pub. Date: Jul. 5, 2007

(54) Information of proximate properties through geographic positioning

(75) Inventor: Sadashiv Adiga, Hercules, CA (US)

Correspondence Address: Raj Abhyanker, LLP;c/o Intellevate, P.O. Box 52050, Minneapolis, MN, 55402, US

(73) Assignee: Oia Intellectuals, Inc.

(21) Appl. No.: 11/517,756

(22) Filed: Sep. 8, 2006

Related U.S. Application Data
(63) Continuation-in-part of application No. 11/318,214, filed on Dec. 23, 2005.

(51) Int. Cl. G06F 17/00

(52) U.S. Cl. 707/104.1

(57) ABSTRACT

Information of proximate properties through geographic positioning is disclosed. In one aspect, a method of a server module includes determining a route of a user to arrive at a set of properties that are indicated of interest to the user based on a geographical location of the user communicated by way of a client module indicating a present location of the user; optimally adjusting the route of the user to drive by the set of properties computed through a mathematical algorithm having a parameter related to the geographical location of the user communicated via a client module indicating a present location of the user; and automatically identifying at least one other marketed property proximal to the geographical location of the user communicated via the client module to the server module indicating the present location of the user in addition to the set of marketed properties based on property databases.

### CLAIM OF PRIORITY

This disclosure is a Continuation in Part (CIP) application, and claims priority from, U.S. pending patent application Ser. No. 11/318,214, filed Dec. 23, 2005.

### FIELD OF TECHNOLOGY

This disclosure relates generally to the technical fields of geographic positioning, and in one example embodiment a system, a method, and/or an apparatus that provides information of proximate properties through geographic positioning.

### BACKGROUND

A potential buyer of real estate may wish to drive in a neighborhood (e.g., a residential, commercial, and/or industrial neighborhood) to look at marketed properties from an exterior before being accompanied by a real estate professional (e.g., an agent, a broker, etc.). The potential buyer may see a physical sign in front of a marketed property (e.g., a ‘for sale’ sign, a ‘for rent’ sign, etc.) indicating a property's market status.

A property site of the marketed property may provide a paper handout created by a seller (e.g., and/or a seller's agent) that has information about the marketed property. The potential buyer may park his automobile, exit his automobile, and/or walk over to pick up the paper handout created by the seller to learn basic information about the marketed property (e.g., asking price, size, number of rooms, and/or year built, etc.). However, the property site may occasionally run out of the paper handouts (e.g., other potential buyers may have taken them). Or, the seller may choose not to provide the paper handouts having information about the marketed property (e.g., for perceived privacy reasons).

Furthermore, the potential buyer may call an information hotline to obtain information about the marketed property. For example, the seller and/or a seller's agent may publish a contact phone number at which the seller and/or the seller's agent can be reached for additional information. The potential buyer may need to physically dial a phone number to obtain information about the marketed property. Both the paper handout and/or a verbal discussion between the potential buyer and the seller and/or the seller's agent may include biased information because the potential buyer may only receive information that the seller and/or the seller's agent feel will facilitate and/or enhance the chances of a transaction of the marketed property.

To conduct objective research, the potential buyer may have to stop at an Internet café, a local library, and/or an office services location (e.g., FedEX® Kinkos®) to obtain objective data (e.g., a price, size, year built, and/or number of rooms, etc.) regarding the marketed property through a regulated service that provides parameter comparisons (e.g., a Multiple Listing Service).

Also, the potential buyer may wish to find other properties like the marketed property in the neighborhood. The potential buyer may need to drive around without directions in an unfamiliar neighborhood to discover streets where there are other marketed properties (e.g., other properties with ‘for sale’ signs) that appear to be of interest. The potential buyer may choose to stop at the office services location (e.g., FedEX® Kinkos®) again to print out driving directions and/or search for other homes marketed in the neighborhood they are visiting through a Multiple Listing Service (MLS). However, a process of printing out driving directions to each property may be inefficient and/or tedious as the potential buyer may not be familiar with the neighborhood. In addition, it may be difficult to obtain driving directions from one property to a next as relative locations between each property may not be known in advance. As a result, the potential buyer may end up spending a considerable amount of time to attempt to find each property and obtain details regarding each property.

### SUMMARY

Information of proximate properties through geographic positioning is disclosed. In one aspect, a method of a server module includes determining a route of a user to arrive at a set of properties that are indicated of interest to the user through a network based on a geographical location of the user communicated by way of a client module indicating a present location of the user; optimally adjusting the route of the user to drive by the set of properties computed through a mathematical algorithm having a parameter related to the geographical location of the user communicated via the client module indicating the present location of the user; and automatically identifying at least one other marketed property proximal to the geographical location of the user communicated via the client module to the server module indicating the present location of the user in addition to a set of marketed properties based on a plurality of property databases.

The method may include automatically re-adjusting the route of the user to drive by the set of properties when the user deviates from an originally computed route that was based on a previous location of the user. The method may process the set of marketed properties based on the user interest and the plurality of property databases to compile a meta-data of the set of marketed properties to present the set of marketed properties to the user in an organized format enabling the user to utilize the route in an efficient manner. Also, the method may generate and/or continuously update a graphical representation of the plurality of positioning information of the set of marketed properties with respect to a real time geographical location indicating the present location of the user determined through a global positioning system that is wirelessly communicated by the client module to the server module.

The method may automatically retrieve property information of the at least one other marketed property proximal to the geographical location indicating the present location of the user determined through the global positioning system and communicated by the client module to the server module. The method may provide a one click access to retrieve information of the at least one other marketed property comprising textual attributes of a pricing data, a size data, an age data, graphical representations having pictures, sketches, architectural blue prints, and a virtual tour of the at least one other marketed property. The method may interactively modify the route to incorporate directions to the at least one other marketed property through communicating with the plurality of property databases and continuously update a distance between the geographical location of the user indicating the present location of the user and each marketed property that is indicated of interest of the user.

In another aspect, a method of a server module includes automatically identifying a set of marketed properties that have a plurality of characteristics similar to a particular property having close proximity to a geographical location of a user indicating a present location of the user that is wirelessly communicated by a client module to the server module; and scheduling an appointment between the user and a real estate professional to expedite a tour of the particular property of the set of marketed properties based on a property information of the particular property automatically retrievable from at least one of a plurality of property databases through a communication between the client module to the server module.

The method may further include processing the plurality of characteristics similar to the particular property and generating an identifier data based on a meta-data of the particular property and identifying another set of marketed properties having a similar set of characteristics based on a correlation of the identifier data. Furthermore, the method may identify another set of marketed properties having the similar set of characteristics that is located within a particular distance from the geographic location of the user indicating the user's present location through a computation model based on a mathematical algorithm having a parameter that accounts for a distance between the user and each marketed property.

The method may incorporate a direction to the another set of marketed properties having the similar set of characteristics to a route to arrive at a marketed properties of interest to the user based on the geographical location indicating the present location of the user. In addition, the method may generate an optimal appointment schedule of the user to tour the marketed property through interactively incorporating any of a real estate professional and a user's schedules through accessing the plurality of property databases and cross referencing the real estate professional's and the user's schedules.

In yet another aspect, a method of a client module includes identifying a present location of a user of the client module based on a positioning information provided through a global positioning system of the client module, providing an optimal route computed through a server module of at least one selected property of a plurality of marketed properties indicated of interest to the user of the client module, providing detailed information of the at last one selected marketed property through a communication of a geographical location of the client module with a server module to facilitate the server module in retrieving a property information of a marketed property of close proximal distance to the user of the client module, and generating an interactive interface that enables the user of the client module to initiate the plurality of requests (e.g., the property information retrieval, the optimal route, a similar property search, an appointment schedule, etc.) to the server module via wireless communication.

The geographical location of the user of the client module may indicate the present location of the user of the client module when the similar property search request is generated by the user of the client module and the geographical location of the user of client module indicating the present location of the user of the client module is communicated to the server module. The method may generate an interactive graphical representation of the optimal route provided by the server module based on the geographical location of the user of the client module indicating the present location of the user of the client module that is determined by the global positioning system. The method may generate a textual representation of the optimal route by the server module comprising at least any of the positioning information of each of the plurality of properties for sale of interest to the user of the client module, a status data, a pricing data, a size data, and/or an age data. The method may enable the user of the client module to input a score of each of the plurality of properties that the user of the client module has toured through a ranking mechanism of an interactive interface.

The interactive interface may further enable the user of client module to request a viewing of any of a pictorial representation and a video representation data of the plurality of properties for sale communicated to the client module by the server module.

In a further aspect, a system includes a client module operated by a property shopper to determine a geographical location of the property shopper based on a positioning information provided through a global positioning system of the client module communicated to a server module through a network and wherein the client module includes a one click module of the client module to automatically identify at least one marketed property proximal to the geographical location of the property shopper and to retrieve property information of the at least one marketed property proximal to the geographical location of the property shopper; and the server module to process the geographical location that determines a current location of the property shopper, to generate an optimally efficient route, to inspect a plurality of marketed properties, to communicate the optimally efficient route to the client module through the network, and to streamline a property shopping process of the property shopper.

The server module may automatically re-adjust a route when the property shopper deviates from an initially computed routed that was based on a previous location of the property shopper. The server module may process the plurality of marketed properties based on the property shopper interest and a plurality of property databases to compile a meta-data of the plurality of marketed properties to present the plurality of marketed properties to the property shopper in an organized format enabling the property shopper to utilize the route in an efficient manner.

The server module may automatically identify at least one other marketed property proximal to the geographical location of the user communicated via the client module to the server module indicating a present location of the user in addition to the set of marketed properties based on the plurality of property databases. The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a server module communicating with a client module and a vehicle through a network, according to one embodiment.

FIG. 2 is an exploded view of the server module of FIG. 1, according to one embodiment.

FIG. 3 is a system view of the vehicle of FIG. 1, according to one embodiment.

FIG. 4 is a user interface view of the client module of FIG. 1, according to one embodiment.

FIG. 5 is a table view of a properties table, according to one embodiment.

FIG. 6 is an exploded view of the client module of FIG. 1, according to one embodiment.

FIG. 7 is an interface view of the client module of FIG. 1, according to one embodiment.

FIG. 8 is a map view illustrating of the client module of FIG. 1 and the vehicle of FIG. 1 an unknown neighborhood, according to one embodiment.

FIG. 9 is a diagrammatic system view of a data processing system in which any of the embodiments disclosed herein may be performed, according to one embodiment.

FIG. 10 is a process flow of a server module, according to one embodiment.

FIG. 11 is a process diagram that describes further the operations of FIG. 10, according to one embodiment.

FIG. 12 is a process flow of a server module, according to one embodiment.

FIG. 13 is a process diagram that describes further the operations of FIG. 12, according to one embodiment.

FIG. 14 is a process flow of a server module, according to one embodiment.

FIG. 15 is a process diagram that describes further the operations of FIG. 12, according to one embodiment.

Other features of the present embodiments will be apparent from the accompanying drawings and from the detailed description that follows.

### DETAILED DESCRIPTION

Information of proximate properties through geographic positioning is disclosed. In the following description, for the purposes of explanation, numerous specific details are set forth in order to provide a thorough understanding of the various embodiments. It will be evident, however to one skilled in the art that various embodiments may be practiced without these specific details.

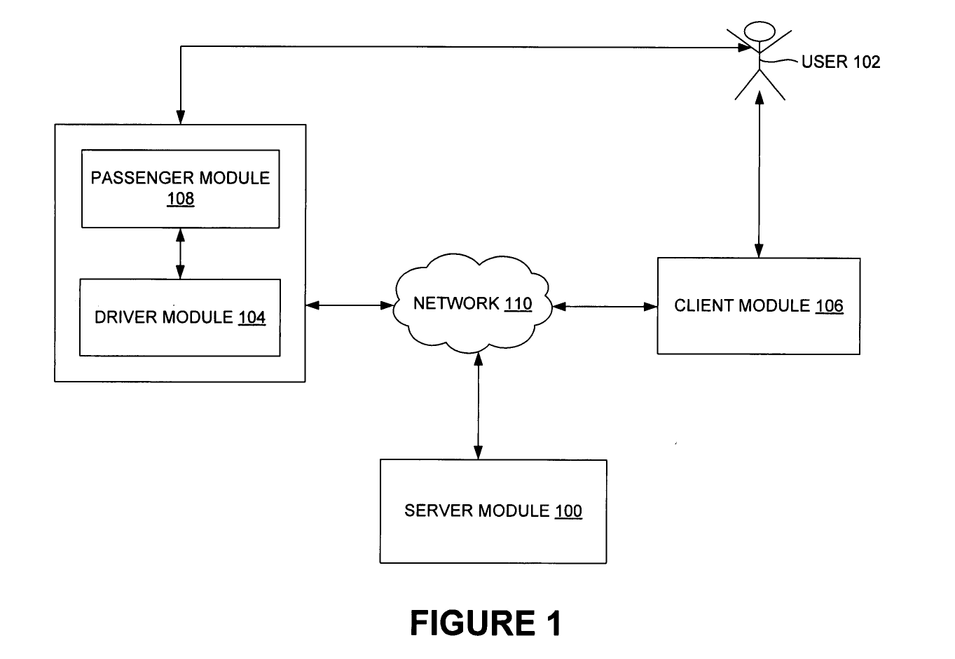

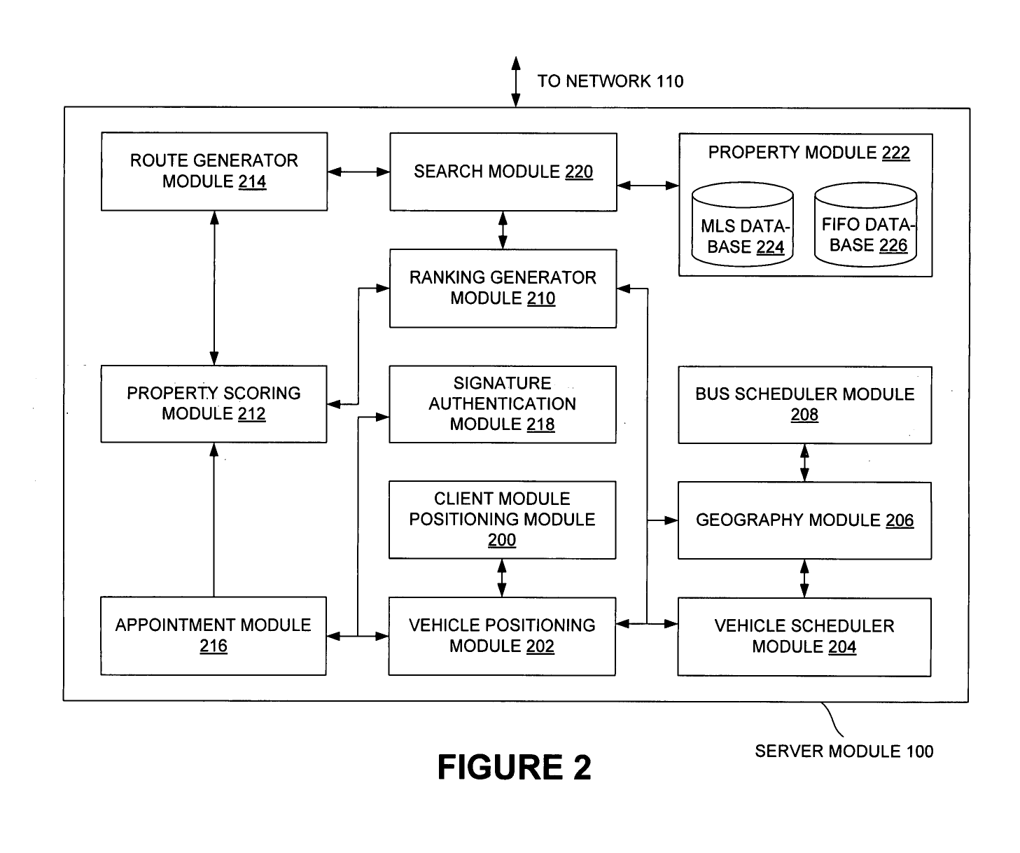

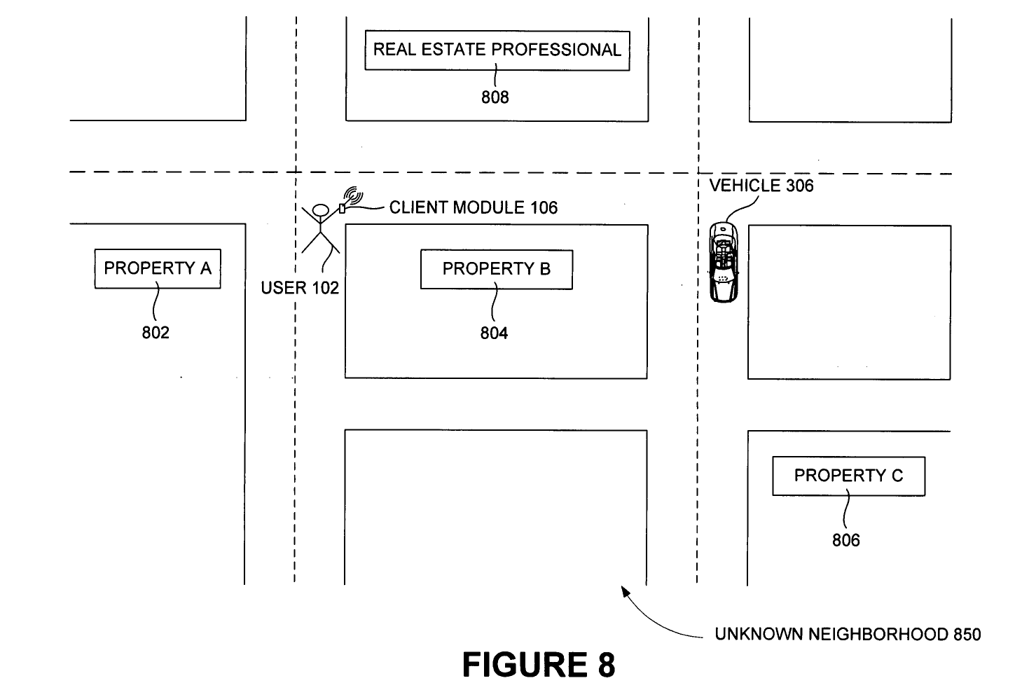

In one embodiment, a method includes determining a route of a user (e.g., the user 102 of FIG. 1) to arrive at a set of properties that are indicated of interest to the user (e.g., the user 102 of FIGS. 1, 8) through a network (e.g., the network 110 of FIG. 1) based on a geographical location of the user communicated by way of a client module (e.g., the client module 106 of FIG. 1) indicating a present location of the user (e.g., the user 102 of FIGS. 1, 8), optimally adjusting the route of the user (e.g., the user 102 of FIGS. 1, 8) to drive by the set of properties computed through a mathematical algorithm having a parameter related to the geographical location of the user (e.g., the user 102 of FIGS. 1, 8) communicated via a client module indicating the present location of the user (e.g., the user 102 of FIGS. 1, 8), and automatically identifying at least one other marketed property proximal to the geographical location of the user (e.g., the user 102 of FIGS. 1, 8) communicated via the client module (e.g., the client module 106 of FIGS. 1, 4, 6-8) to a server module (e.g., the server module 100 of FIGS. 1, 2) indicating the present location of the user (e.g., the user 102 of FIGS. 1, 8) in addition to a set of marketed properties based on property databases.

In another embodiment, a method includes automatically identifying a set of marketed properties (e.g., properties 802-808 of FIG. 8) that have characteristics similar to a particular property (the property 804 of FIG. 8) having close proximity to a geographical location of a user (e.g., the user 102 of FIG. 8) indicating the present location of the user (e.g., the user 102 of FIGS. 1, 8) that is wirelessly communicated by a client module (e.g., the client module 106 of FIG. 8) to a server module (e.g., the server module 100 of FIGS. 1, 2), and scheduling an appointment between the user (e.g., the user 102 of FIGS. 1, 8) and a real estate professional (e.g., the real estate professional 808 of FIG. 8) to expedite a tour of a particular property of the set of marketed properties based on a property information of the particular property automatically retrievable from at least one of a plurality of property databases through a communication between the client module (e.g., the client module 106 of FIGS. 1, 4, 6-8) to the server module (e.g., the server module 100 of FIGS. 1, 2).

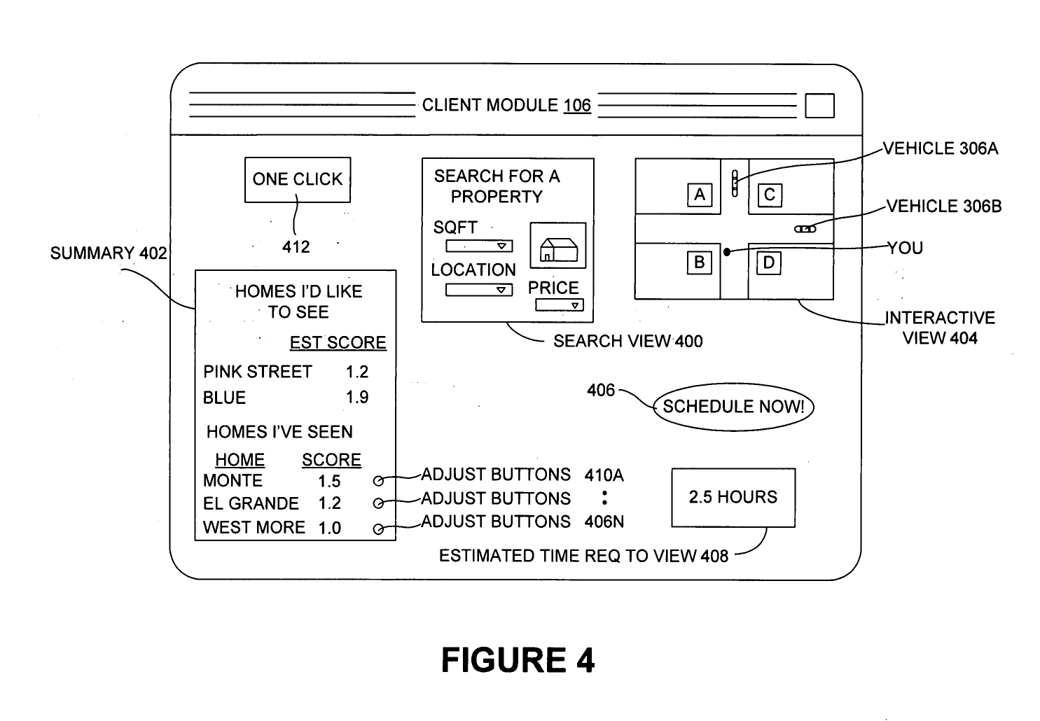

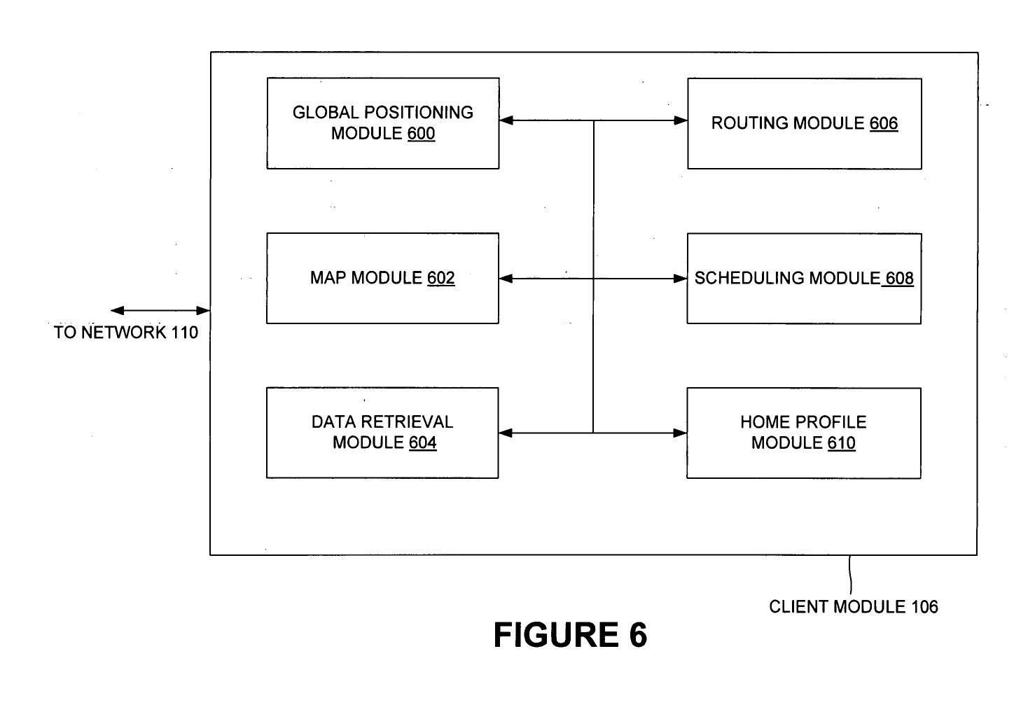

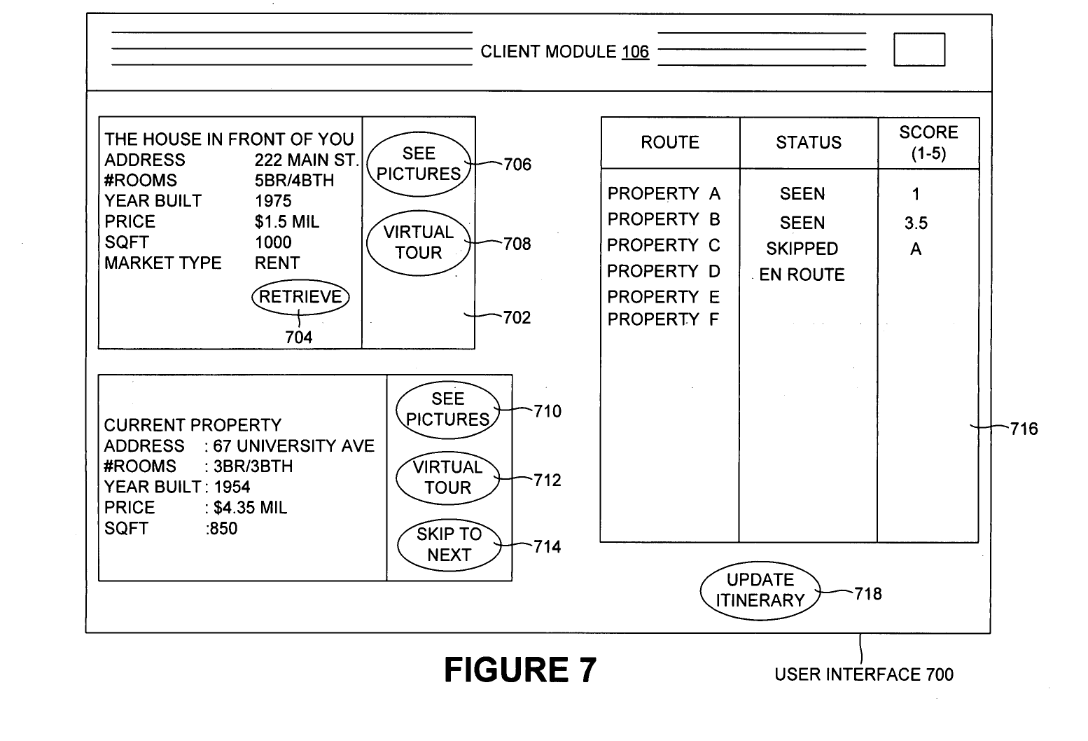

In yet another embodiment, a method includes identifying a present location of a user (e.g., the user 102 of FIGS. 1, 8) of a client module (e.g., the client module 106 of FIGS. 1, 4, 6-8) based on a positioning information provided through a global positioning system of the client module (e.g., as described in FIG. 6), providing an optimal route computed through a server module (e.g., the server module 100 of FIGS. 1, 2) of at least one selected property of a set of marketed properties indicated of interest to the user (e.g., the user 102 of FIGS. 1, 8) of the client module (e.g., the client module 106 of FIGS. 1, 4, 6-8), providing detailed information of the at least one selected marketed property through a communication of the geographical location of the client module (e.g., the client module 106 of FIGS. 1, 4, 6-8) with the server module (e.g., the server module 100 of FIGS. 1, 2) to facilitate the server module (e.g., the server module 100 of FIGS. 1, 2) in retrieving a property information of a marketed property of close proximal distance to the user (e.g., the user 102 of FIGS. 1, 8) of the client module (e.g., the client module 106 of FIGS. 1, 4, 6-8), and generating an interactive interface that enables the user (e.g., the user 102 of FIGS. 1, 8) of the client module to initiate a plurality of requests to the server module (e.g., the server module 100 of FIGS. 1, 2) via wireless communication (e.g., as described in FIG. 6 and as illustrated in FIG. 4 and FIG. 7).

In a further embodiment, a system includes a client module (e.g., the client module 106 of FIG. 1) operated by a property shopper to determine a geographical location of the property shopper (e.g., a user 102 of FIG. 1 and FIG. 8) based on a positioning information provided through a global positioning system of the client module (e.g., the client module 106 of FIGS. 1, 4, 6-8) communicated to a server module (e.g., the server module 100 of FIGS. 1, 2) through a network and wherein the client module (e.g., the client module 106 of FIGS. 1, 4, 6-8) includes a one click module (e.g., as embodied in a one click indicator 412 of FIG. 4) of the client module (e.g., the client module 106 of FIGS. 1, 4, 6-8) to automatically identify at least one marketed property proximal to the geographical location of the property shopper and to retrieve property information of the at least one marketed property proximal to the geographical location of the property shopper; and the server module (e.g., the server module 100 of FIGS. 1, 2) to process the geographical location that determines a current location of the property shopper, to generate an optimally efficient route, to inspect a plurality of marketed properties, to communicate the optimally efficient route to the client module (e.g., the client module 106 of FIGS. 1, 4, 6-8) through the network, and to streamline a property shopping process of the property shopper.

FIG. 1 is a system view of a server module 100 communicating with a user 102 through a network 110, according to one embodiment. Particularly, FIG. 1 illustrates the server module 100, the user 102, a driver module 104, a client module 106, a passenger module 108, and the network 110, according to one embodiment.

The server module 100 may be a workstation and/or computer with properties information. The properties information may include the number of rooms, year built, price, size, zone (e.g., industrial, commercial, residential, etc.), type (e.g., sale, lease, etc.) and/or any other pertinent data. The user 102 may be a prospective buyer, prospective renter, prospective seller, and/or real estate agent. The driver module 104 may be a computer (e.g., laptop) attached to (e.g., mounted on a dashboard of) a vehicle (e.g., a car, a taxi, a bus, a van, a shuttle, a plane, a boat, a rickshaw, a cycle, etc.). The client module 106 may be a personal digital assistant, a phone, a computer, a cellular device, a satellite device, and/or any other GPS-enabled device that is associated and accessible by the user 102. The passenger module 108 may be a computer (e.g., a laptop) attached to (e.g., mounted on a back of a passenger seat of) the vehicle. The network 110 may be a wide-area network, a local-area network, a mobile network, and/or any other computer network.

In addition, as illustrated in FIG. 1, the client module 106 communicates with the server module 100 through the network 110. The driver module 104 may also communicate with the server module 100 through the network 110. Similarly, the passenger module of the user 102 may also communicate with the server module 100 through the network 110. The user 102 may directly communicate either with the client module 106 and/or the passenger module 108 as illustrated in FIG. 1 (e.g., depending on whether the user 102 is in a vehicle or not).

The client module 106 may be operated by a property shopper (e.g., a user 102 of FIG. 1). The client module 106 may determine a geographical location of the property shopper based on a positioning information provided through a global positioning system (e.g., GPS) communicated to a server module 100 through a network 110 and wherein the client module 106 may include a one click module of the client module (e.g., that may be actuated by the property shopper such as a user 102 of FIG. 1). The one click module (e.g., in the form of a one click indicator 412 of FIG. 4) may automatically identify at least one marketed property proximal to the geographical location of the property shopper and may retrieve property information of the at least one marketed property proximal to the geographical location of the property shopper, according to one embodiment.

In addition, the server module 100 may process the geographical location that determines the current location of the property shopper and may generate an optimally efficient route of the property shopper to inspect a plurality of marketed properties. The server module 100 may communicate the optimally efficient route to the client module 106 through the network 110 to streamline a property shopping process of the property shopper, according to one embodiment.

FIG. 2 is an exploded view of the server module 100 of FIG. 1, according to one embodiment. Particularly, FIG. 2 illustrates a client module positioning module 200, a vehicle positioning module 202, a vehicle scheduling module 204, a geography module 206, a bus scheduler module 208, a ranking generator module 210, a property scoring module 212, a route generator module 214, an appointment module 216, a signature authentication module 218, a search module 220, a property module 222, a Multiple Listing Service (MLS) database 224, and a First-In First-Out (FIFO) database 226, according to one embodiment.

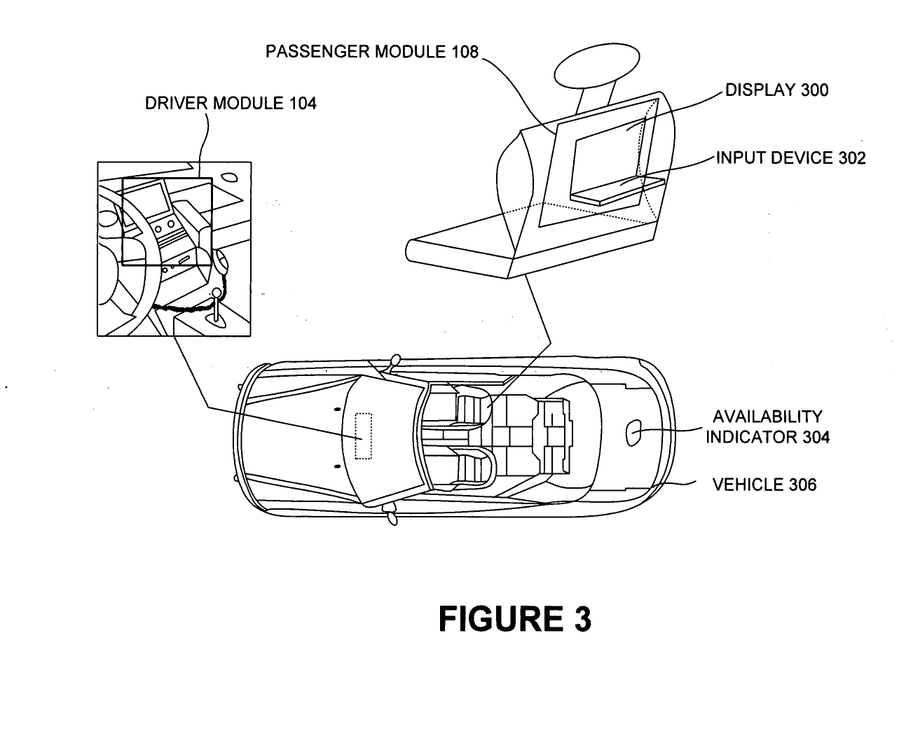

The client module positioning module 200 may provide a geographical information indicating the present location of a user 102 communicated via a client module 106 through a network 110 to the server module 100. The vehicle positioning module 202 may provide the geographical information of the user 102 indicating a present location of a transport vehicle (e.g., a vehicle 306 of FIG. 3) communicated via a driver module 104 and/or a passenger module 108 through a network 110 to the server module 100. The vehicle scheduler module 204 may compute a time for the user 102 to be picked up by a real estate agent. The geography module 206 may process the geographical location of the user 102 and/or the transport vehicle (e.g., vehicle 306 of FIG. 3). The bus scheduler module 208 may use information associated with a position of the client module 106 (e.g., from the client module positioning module 200), a request (e.g., a request from a schedule now indicator 406 of FIG. 4), and/or the location of the property (e.g., based on data communicated by the MLS database 224 of the property module 222) to compute a time for the user 102 to be picked up by a transport vehicle (e.g., bus) and taken to the property. The ranking generator module 210 may use property scores (e.g., from the property scoring module 212) to determine a ranking of the marketed properties of interest to the user 102. The property scoring module 212 may compute a score of the property based on a set of characteristics. The route generator module 214 may determine an optimal route of the user 102 to visit (e.g., tour, drive-by, etc.) the property.

The appointment module 216 may provide the user 102 with an appointment with a real estate agent for a tour of a property. The signature authentication module 218 may verify an identity information of the user 102 (e.g., signature, thumbprint, voice, retinal, etc.). The property module 220 may provide the properties information of a number of properties obtained from a number of property databases. The search module 222 may process the set of characteristics indicted to be of interest by the user 102 and the properties information of several property databases of the property module 220. The MLS database 224 may provide the properties information to the server module 100 from a Multiple Listing Service (MLS) database. The FIFO database 226 may provide the properties information to the server module 100 from a First-in First-out (FIFO) database.

In the example embodiment illustrated in FIG. 2, the client module positioning module 200 communicates with the vehicle positioning module 202. The vehicle positioning module 202 communicates with the vehicle scheduler module 204, the geography module 206, the ranking generator module 210, the appointment module 216, and the signature module 218. The vehicle scheduler module 204 communicates with the geography module 206, which communicates with the bus scheduler module 208. The ranking generator module 210 communicates with the property scoring module 212. The property scoring module 212 communicates with the route generator module 214. The appointment module 216 communicates with the property scoring module 212. The search module 220 communicates with the property module 222.

For example, a route of the user 102 to arrive at a set of properties that are indicated of interest to the user 102 may be determined (e.g., using the route generator module 214 in FIG. 2) through the network 110 based on a geographical location of the user communicated by way of a client module 106 indicating a present location of the user 102. The route of the user 102 may be optimally adjusted to drive by the set of properties computed through a mathematical algorithm having a parameter related to the geographical location of the user 102 communicated via a client module 106 indicating a present location of the user 102. At least one other marketed property may be automatically identified as proximal to the geographical location of the user communicated via the client module 106 to the server module 100 indicating the present location of the user in addition to the set of marketed properties based on a number of property databases. In addition, the route of the user 102 to drive by the set of properties may be automatically readjusted when the user 102 deviates from an originally computed route that was based on a previous location of the user 102.

Furthermore, a property information of the at least one other marketed property proximal to the geographical location indicating the present location of the user 102 determined through the global positioning system and communicated by the client module 106 to the server module 100 may be automatically retrieved (e.g., using the property module 220 of FIG. 2).

In addition, a set of marketed properties may be automatically identified to have a plurality of characteristics similar to a particular property having close proximity to a geographical location of a user indicating the present location of the user that is wirelessly communicated by a client module 106 to the server module 100. An appointment may be scheduled between the user 102 and a real estate professional to expedite a tour of a particular property of the set of marketed properties based on a property information of the particular property, which may be automatically retrieved from at least one of a number of property databases (e.g., the property module 222, the MLS database 224 and/or the FIFO database 226 of FIG. 2) through a communication between the client module 106 to the server module 100.

A plurality of characteristics similar to the particular property may be processed and an identifier data may be generated based on the meta-data of the particular property (e.g., through the appointment module 216). Another set of marketed properties may be identified having a similar set of characteristics based on a correlation of the identifier data. Another set of marketed properties may be identified to have the similar set of characteristics and may be located within a particular distance from the geographic location of the user indicating the user's present location (e.g., through the geography module 206) through a computation model based on a mathematical algorithm having a parameter that accounts for the distance between the user and each marketed property (e.g., through the property module 212).

A direction to an another set of marketed properties may be incorporated to the similar set of characteristics to a route to arrive at the marketed properties of interest to the user 102 based on the geographical location indicating the present location of the user. An optimal appointment schedule of the user 102 to tour the marketed property may be generated through interactively incorporating any of a real estate professional and a user's schedules (e.g. through the appointment module 216) through accessing the plurality of property databases and cross referencing the real estate professional's and the user's schedules.

FIG. 3 is a vehicle view of the driver module 104 of FIG. 1 and the passenger module 108 of FIG. 1, according to one embodiment. Particularly, FIG. 3 illustrates a display 300, an input device 302, an availability indicator 304, and a vehicle 306, according to one embodiment.

The display 300 may be a screen (e.g., a LCD screen, etc.). The input device 302 may be keypad (e.g., an alphanumeric keypad, a QUERTY keyboard, etc.). The availability indicator 304 may be a signal. The vehicle 306 may be any transport vehicle (e.g., a car, a taxi, a van, a boat, a plane, etc.).

FIG. 4 is a user interface view of the client module 106 of FIG. 1, according to one embodiment. Particularly, FIG. 4 illustrates a search view 400, a summary 402, an interactive view 404, a schedule now indicator 406, an estimated time required to view indicator 408, and adjust indicators 410, and a one click indicator 412 according to one embodiment.

The search view 400 may input a set of characteristics selected by the user 102 into the client module 106 for processing by the server module 100. The summary 402 may indicate information (e.g., property scores) for a number of properties. The interactive view 404 may provide a graphical representation of the number of properties proximal to the geographic location of the user 102 of the client module 106. The schedule now indicator may provide the server module 100 with a request by the user 102 for a tour of a particular property by a real estate agent. The estimated time required to view indicator 408 may indicate the number of hours and/or minutes which the user 102 may need to view the particular property. The adjust indicators 410 may provide a manual override to home score settings as illustrated in FIG. 4. The one click indicator 412 may provide a single click access to real estate information (e.g., details of a marketed property listing) automatically to a user of a marketed property in close vicinity to the user (e.g., directly in front of the user) based on a geographic positioning system.

A one click access may be provided to retrieve information of the at least one other marketed property comprising textual attributes of a pricing data, a size data, an age data, graphical representations having pictures, sketches, architectural blue prints, and a virtual tour of the at least one other marketed property.

The set of marketed properties may be processed based on user interest and the plurality of property databases to compile a metadata of the set of marketed properties to present the set of marketed properties to the user in an organized format enabling the user 102 to utilize the route in an efficient manner.

A graphical representation of a plurality of positioning information of the set of marketed properties may be generated and continuously updated with respect to the real time geographical location indicating the present location of the user 102 determined through a global positioning system that is wirelessly communicated by the client module to the server module. An interactive graphical representation of the optimal route provided by the server module may be generated based on the geographical location of the user of the client module indicating the present location of the user of the client module that is determined by the global positioning system. The user of the client module may be enabled to input a score of each of the plurality of properties that the user 102 of the client module 106 has toured through a ranking mechanism of the interactive interface.

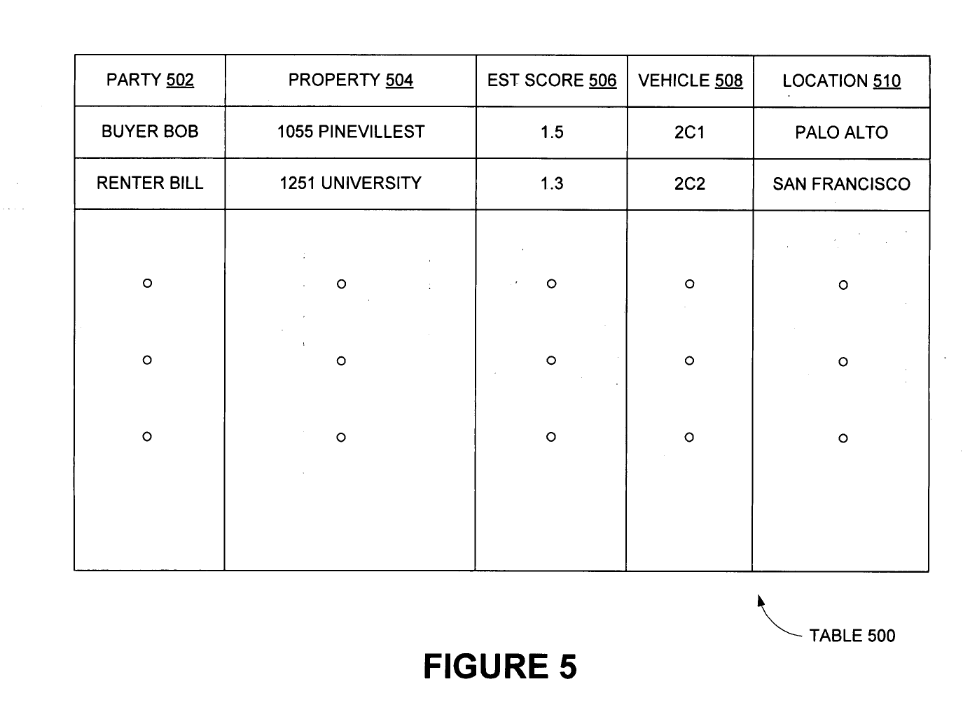

FIG. 5 is a table view of properties table 500, according to one embodiment. Particularly, FIG. 5 illustrates the properties table 500, a party field 502, a property field 504, a estimated score field 506, a vehicle field 508, and a location field 510, according to one embodiment. The properties table 500 may include information related to marketed properties. The party field 502 may indicate information related to identification of owners of marketed properties. The property field 504 may indicate locations of the marketed properties. The estimated score field 506 may indicate scores (e.g., ranks) of marketed properties. The vehicle field 508 may indicate information related to identification of a transport vehicle (e.g., vehicle 306 of FIG. 3). The location field 510 may indicate the cities of the marketed properties.

FIG. 6 is an exploded view of the client module 106 of FIG. 1, according to one embodiment. Particularly, FIG. 6 illustrates a global positioning module 600, a map module 602, a data retrieval module 604, a routing module 606, a scheduling module 608, and a home profile module 610, according to one embodiment. The global positioning module 600 may provide information about a present location of a user of a device near a marketed property. The map module 602 may generate a graphical representation of an area surrounding the user. The routing module 606 may generate a route to various homes in vicinity to the user. The scheduling module 608 may provide a schedule of nearby properties the user may wish to visit and have preprogrammed. The home profile module 610 may provide detailed information of a marketed property near (e.g., in front of) the user.

A present location of a user of the client module may be identified based on a positioning information provided through a global positioning system of the client module (e.g., and stored in the location field 510). An optimal route may be computed through a server module of at least one selected property of a plurality of marketed properties indicated of interest to the user of the client module (e.g., may be provided to a vehicle identified through the vehicle field 508). Detailed information of the at last one selected marketed property may be provided through a communication of the geographical location of the client module with a server module (e.g., a buyer identified in the party field 502). The server module may retrieve a property information of a marketed property of close proximal distance to the user of the client module (e.g., may be property information associated with the property field 504).

The set of requests may include at least one of a property information retrieval, an optimal route, a similar property search, and an appointment schedule. The geographical location of the user of the client module indicating a present location of the user of the client module may be determined when the similar property search request is generated by the user of the client module and the geographical location of the user of client module indicating the present location of the user of the client module is communicated to the server module (e.g., to determine the appropriate vehicle shown in the vehicle field 508 in close proximity to the date shown in the party field 502).

FIG. 7 is an interface view of the client module 106 of FIG. 1, according to one embodiment. Particularly, FIG. 7 illustrates a user interface 700, a the house in front of you indicator 702, a retrieve indicator 704, a see pictures indicator 706, a virtual tour indicator 708, a see pictures indicator 710, a virtual tour indicator 712, a skip to next indicator 714, an itinerary 716, and a update itinerary indicator 718, according to one embodiment. The user interface 700 may be an interface of a mobile device carried by a prospective purchaser/lessor of real estate. The house in front of you indicator 702 may indicate information nearby to the user (e.g., in front of the user). The retrieve indicator 704 may provide information of a home/marketed property nearby to the user. The see pictures indicator 706 may indicate a way for the user to visually experience a marketed property. The virtual tour indicator 708 and the virtual tour indicator 712 may provide details of a simulated home tour to the user. The see pictures indicator 710 may provide images of the marketed property. The skip to the next indicator 714 may enable the user to jump to another marketed property. The itinerary 716 may illustrate a path that the user may follow to find marketed properties and may be pre-selected by the user. The update itinerary indicator 718 may provide a way to update an itinerary of the user.

The route may be interactively modified to incorporate directions to the at least one other marketed property through communicating with the number of property databases (e.g., MLS database 224 and/or FIFO database 226 of the property module 222 of FIG. 2) and continuously updating a distance between the geographical location of the user indicating the present location of the user and each marketed property that is indicated of interest of the user 102.

An interactive interface may be generated in order to enable the user of the client module to initiate a plurality of requests to the server module via wireless communication (e.g., as illustrated in the interactive view 404 of FIG. 4 and/or which is shown in the itinerary 716 of FIG. 7). A textual representation of the optimal route may be generated by the server module, which may include at least any of the positioning information of each of the plurality of properties for sale of interest to the user of the client module, a status data, a pricing data, a size data, and an age data (e.g., as illustrated in itinerary 716 of FIG. 7). The interactive interface may further enable the user of client module to request a viewing of any of a pictorial representation and a video representation data of the plurality of properties for sale communicated to the client module by the server module (e.g., as illustrated in the see pictures indicator 706 of FIG. 7 and the virtual tour indicator 708 of FIG. 7).

FIG. 8 is a system view illustrating the property shopping of a user 102 in an unknown neighborhood 850, according to one embodiment. Particularly, FIG. 8 illustrates the user 102 having the client module 106 (of FIG. 1), a property A 802, a property B 804, a property C 806, a real estate professional 808, a vehicle 810, and the unknown neighborhood 850, according to one embodiment. The property A 802, the property B 804, and the property C 806 may be marketed properties in a particular neighborhood. The real estate professional 808 may be a real estate agent, a broker, appraiser, and/or other professional who deals in transactions of properties. The vehicle 810 may be a car of a real estate professional that automatically picks up a user based on a signal provided through the client device. The unknown neighborhood 850 may be an area of town unfamiliar to the user.

The route of the property shopper to drive by the plurality of marketed pluralities may be automatically readjusted by the server module 100 when the property shopper deviates from an initially computed routed that was based on a previous location of the property shopper. The plurality of marketed properties based on property shopper interest and a plurality of property databases may be processed by the server module 100 in order to compile a metadata of the plurality of marketed properties to present the plurality of marketed properties to the property shopper in an organized format enabling the property shopper to utilize the route in an efficient manner. At least one other marketed property may be automatically identified as proximal to the geographical location of the user communicated via the client module 106 to the server module 100 indicating the present location of the user in addition to the set of marketed properties based on a plurality of property databases.

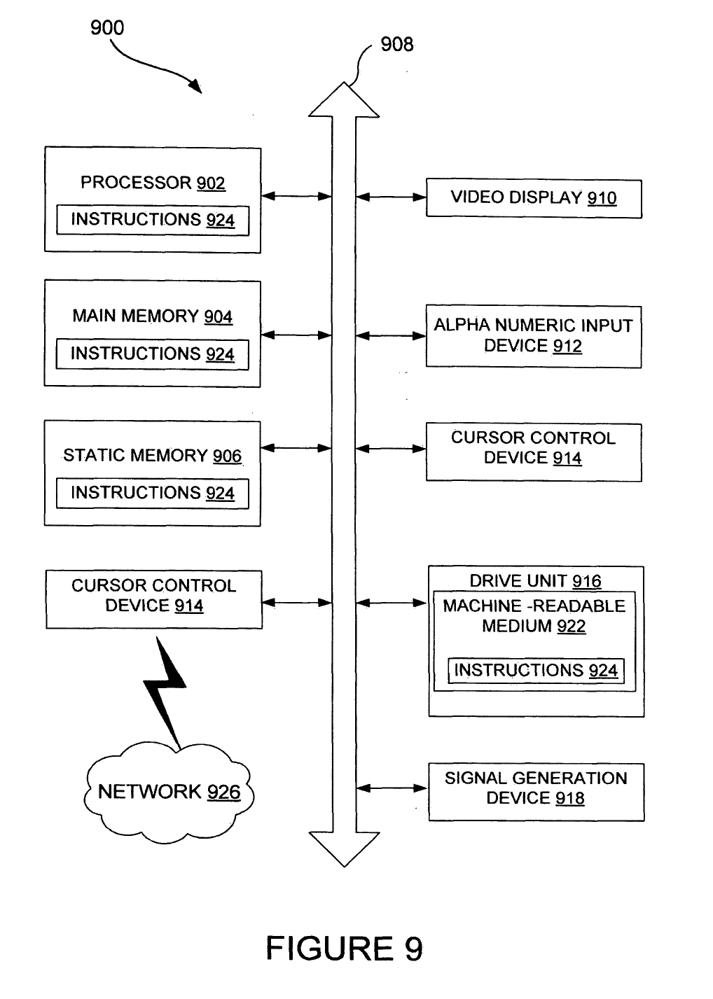

FIG. 9 is a diagrammatic system view of a data processing system 900 in which any of the embodiments disclosed herein may be performed, according to one embodiment. Particularly, the data processing system 900 of FIG. 9 illustrates a processor 902, a main memory 904, a static memory 906, a bus 908, a video display 910, an alpha-numeric input devise 912, a cursor control device 914, a drive unit 916, a signal generation device 918, a network interface device 920, a machine-readable medium 922, an instructions 924, and a network 926, according to one embodiment.

The data processing system 900 may indicate a personal computer and/or a data processing system in which one or more operations disclosed herein are performed. The processor 902 may be microprocessor, a state machine, an application specific integrated circuit, a field programmable gate array, etc. (e.g., Intel® Pentium® processor). The main memory 904 may be a dynamic random access memory and/or a primary memory of a computer system. The static memory 906 may be a hard drive, a flash drive, and/or other memory information associated with the data processing system. The bus 908 may be an interconnection between various circuits and/or structures of the data.

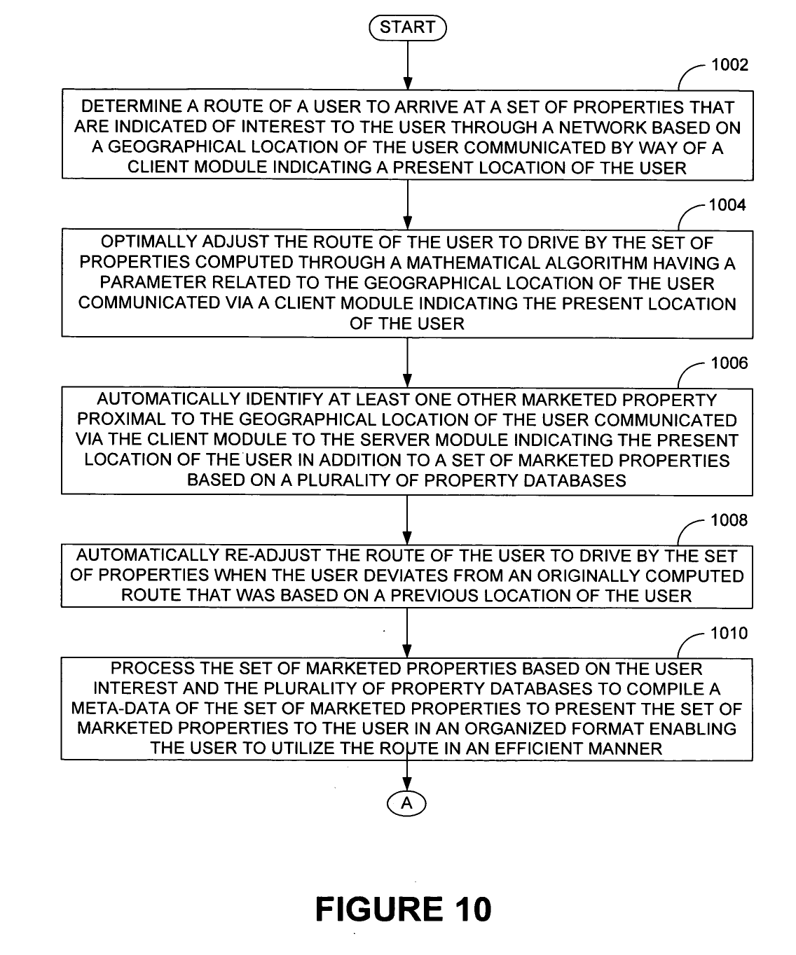

FIG. 10 is a process flow of a server module (e.g., the server module 100 of FIGS. 1, 2), according to one embodiment. In operation 1002, a route of a user (e.g., the user 102 of FIGS. 1, 8) may be determined to arrive at a set of properties (e.g., the property, property A-C 504, 802, 804, 806 of FIGS. 5, 8) that are indicated of interest to the user (e.g., the user 102 of FIGS. 1, 8) through a network (e.g., the network 110 of FIG. 1) based on a geographical location (e.g., the location 510 of FIG. 5) of the user (e.g., the user 102 of FIGS. 1, 8) communicated by way of a client module (e.g., the client module 106 of FIGS. 1, 4, 6-8) indicating a present location (e.g., the location 510 of FIG. 5) of the user (e.g., the user 102 of FIGS. 1, 8). In operation 1004, the route of the user (e.g., the user 102 of FIGS. 1, 8) may be optimally adjusted to drive by the set of properties (e.g., the property, property A-C 504, 802, 804, 806 of FIGS. 5, 8) computed through a mathematical algorithm having a parameter related to the geographical location (e.g., the location 510 of FIG. 5) of the user (e.g., the user 102 of FIGS. 1, 8) communicated via a client module (e.g., the client module 106 of FIGS. 1, 4, 6-8) indicating the present location (e.g., the location 510 of FIG. 5) of the user (e.g., the user 102 of FIGS. 1, 8).

In operation 1006, at least one other marketed property (e.g., the property, property A-C 504, 802, 804, 806 of FIGS. 5, 8) may be automatically identified proximal to the geographical location (e.g., the location 510 of FIG. 5) of the user (e.g., the user 102 of FIGS. 1, 8) communicated via the client module (e.g., the client module 106 of FIGS. 1, 4, 6-8) to the server module a indicating the present location (e.g., the location 510 of FIG. 5) of the user (e.g., the user 102 of FIGS. 1, 8) in addition to a set of marketed properties based on a plurality of property (e.g., the property, property A-C 504, 802, 804, 806 of FIGS. 5, 8) databases. In operation 1008, the route of the user (e.g., the user 102 of FIGS. 1, 8) may be automatically re-adjusted to drive by the set of properties (e.g., the property, property A-C 504, 802, 804, 806 of FIGS. 5, 8) when the user (e.g., the user 102 of FIGS. 1, 8) deviates from an originally computed route that was based on a previous location (e.g., the location 510 of FIG. 5) of the user (e.g., the user 102 of FIGS. 1, 8).

In operation 1010, the set of marketed properties may be processed based on the user (e.g., the user 102 of FIGS. 1, 8) interest and the plurality of property databases to compile a meta-data of the set of marketed properties (e.g., properties 802-808 of FIG. 8) to present the set of marketed properties (e.g., properties 802-808 of FIG. 8) to the user (e.g., the user 102 of FIGS. 1, 8) in an organized format enabling the user (e.g., the user 102 of FIGS. 1, 8) to utilize the route in an efficient manner.

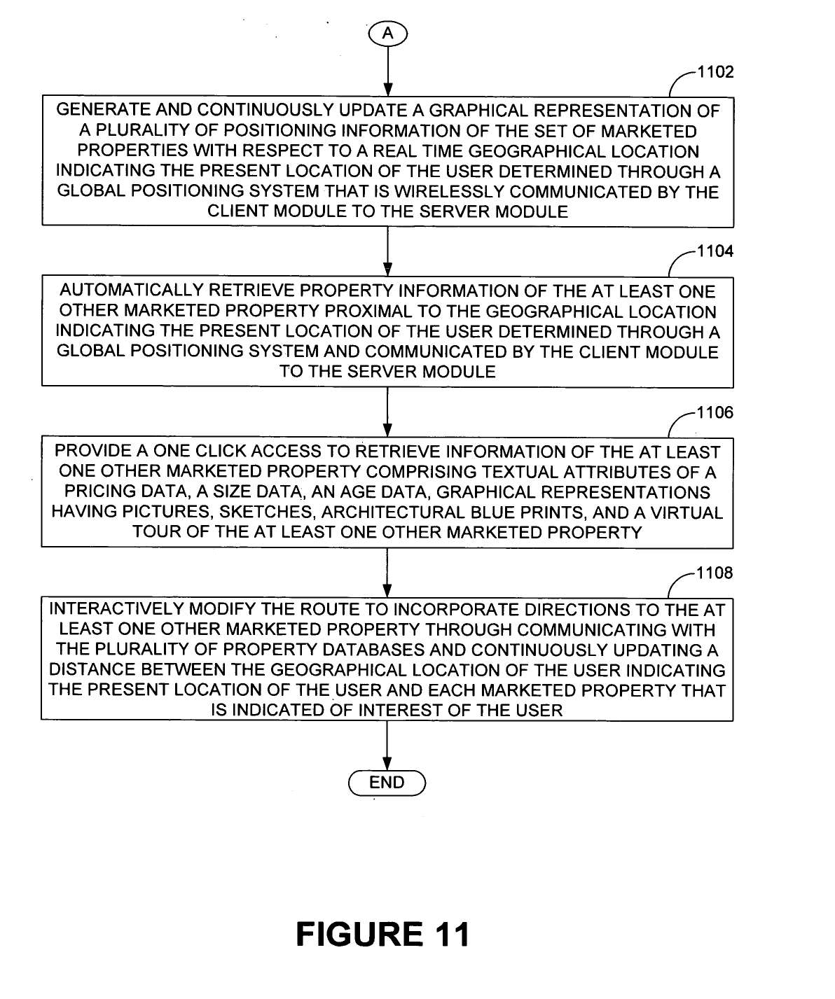

FIG. 11 is a process diagram that describes further the operations of FIG. 10, according to one embodiment. In operation 1102, a graphical representation of a plurality of positioning information of the set of marketed properties (e.g., properties 802-808 of FIG. 8) may be generated and continuously updated with respect to a real time geographical location (e.g., the location 510 of FIG. 5) indicating the present location of the user (e.g., the user 102 of FIGS. 1, 8) determined through a global positioning system that is wirelessly communicated by the client module (e.g., the client module 106 of FIGS. 1, 4, 6-8) to the server module (e.g., the server module 100 of FIGS. 1, 2). In operation 1104, property information of the at least one other marketed property proximal to the geographical location (e.g., the location 510 of FIG. 5) indicating the present location of the user (e.g., the user 102 of FIGS. 1, 8) determined may be automatically retrieved through a global positioning system and communicated by the client module (e.g., the client module 106 of FIGS. 1, 4, 6-8) to the server module (e.g., the server module 100 of FIGS. 1, 2).

In operation 1106, a one click access may be provided to retrieve information of the at least one other marketed property (e.g., the property, property A-C 504, 802, 804, 806 of FIGS. 5, 8) comprising textual attributes of a pricing data, a size data, an age data, graphical representations having pictures, sketches, architectural blue prints, and a virtual tour of the at least one other marketed property (e.g., the property, property A-C 504, 802, 804, 806 of FIGS. 5, 8). In operation 1108, the route to incorporate directions to the at least one other marketed property may be interactively modified through communicating with the plurality of property databases and continuously updating a distance between the geographical location of the user (e.g., the user 102 of FIGS. 1, 8) indicating the present location (e.g., the location 510 of FIG. 5) of the user (e.g., the user 102 of FIGS. 1, 8) and each marketed property (e.g., property 802-808 of FIG. 8) that is indicated of interest of the user (e.g., the user 102 of FIGS. 1, 8).

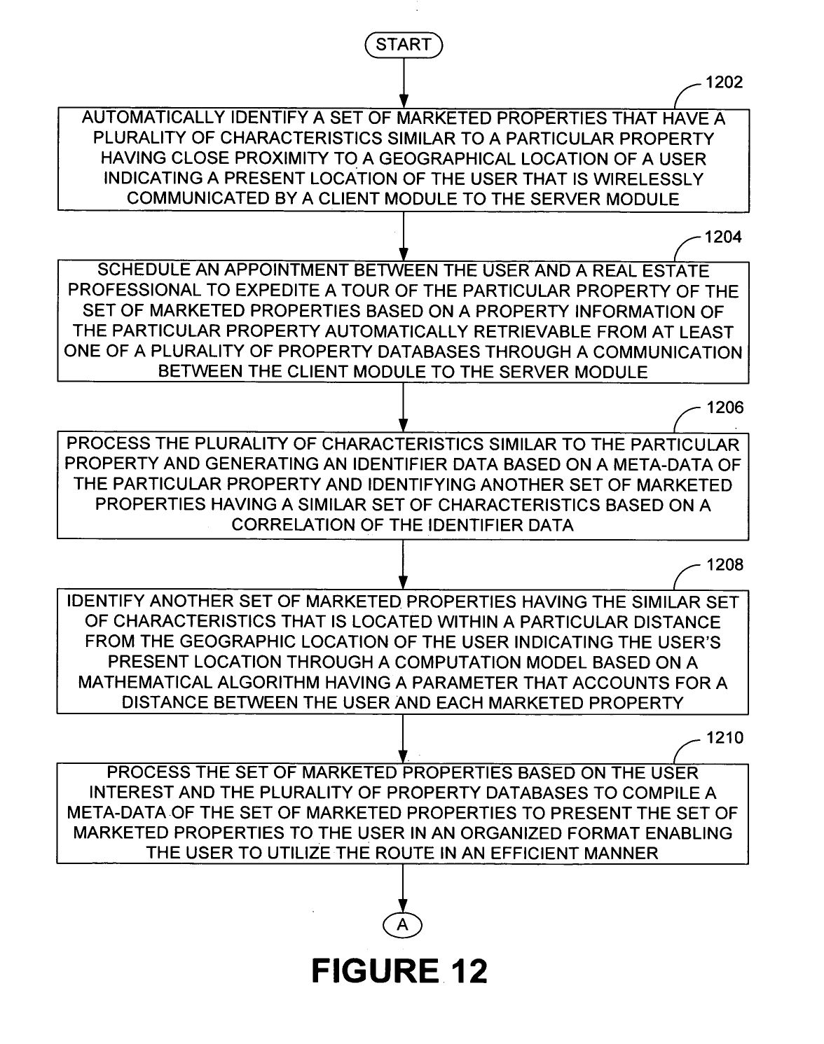

FIG. 12 is a process flow of a server module (e.g., the server module 100 of FIGS. 1, 2), according to one embodiment. In operation 1202, a set of marketed properties (e.g., properties 802-808 of FIG. 8) that have a plurality of characteristics similar to a particular property (e.g., properties 802-808 of FIG. 8) having close proximity to a geographical location of a user (e.g., the user 102 of FIGS. 1, 8) indicating a present location (e.g., the location 510 of FIG. 5) of the user (e.g., the user 102 of FIGS. 1, 8) that is wirelessly communicated by a client module (e.g., the client module 106 of FIGS. 1, 4, 6-8) to the server module (e.g., the server module 100 of FIGS. 1, 2) may be automatically identified.

In operation 1204, an appointment between the user (e.g., the user 102 of FIGS. 1, 8) and a real estate professional (e.g., a real estate professional 808 of FIG. 8) to expedite a tour of the particular property of the set of marketed properties (e.g., properties 802-808 of FIG. 8) may be scheduled based on a property information of the particular property automatically retrievable from at least one of a plurality of property (e.g., properties 802-808 of FIG. 8) databases through a communication between the client module (e.g., the client module 106 of FIGS. 1, 4, 6-8) to the server module (e.g., the server module 100 of FIGS. 1, 2).

In operation 1206, the plurality of characteristics similar to the particular property and generating an identifier data may be processed based on a meta-data of the particular property and identifying another set of marketed properties having a similar set of characteristics based on a correlation of the identifier data. In operation 1208, another set of marketed properties having the similar set of characteristics that is located within a particular distance from the geographic location (e.g., the location 510 of FIG. 5) of the user (e.g., the user 102 of FIGS. 1, 8) indicating the user's (e.g., the user 102 of FIGS. 1, 8) present location (e.g., the location 510 of FIG. 5) through a computation model may be identified based on a mathematical algorithm having a parameter that accounts for a distance between the user and each marketed property.

In operation 1210, a direction to another set of marketed properties having the similar set of characteristics to a route to arrive at a marketed properties (e.g., properties 802-808 of FIG. 8) of interest to the user (e.g., the user 102 of FIGS. 1, 8) may be incorporated based on the geographical location (e.g., the location 510 of FIG. 5) indicating the present location of the user (e.g., the user 102 of FIGS. 1, 8).

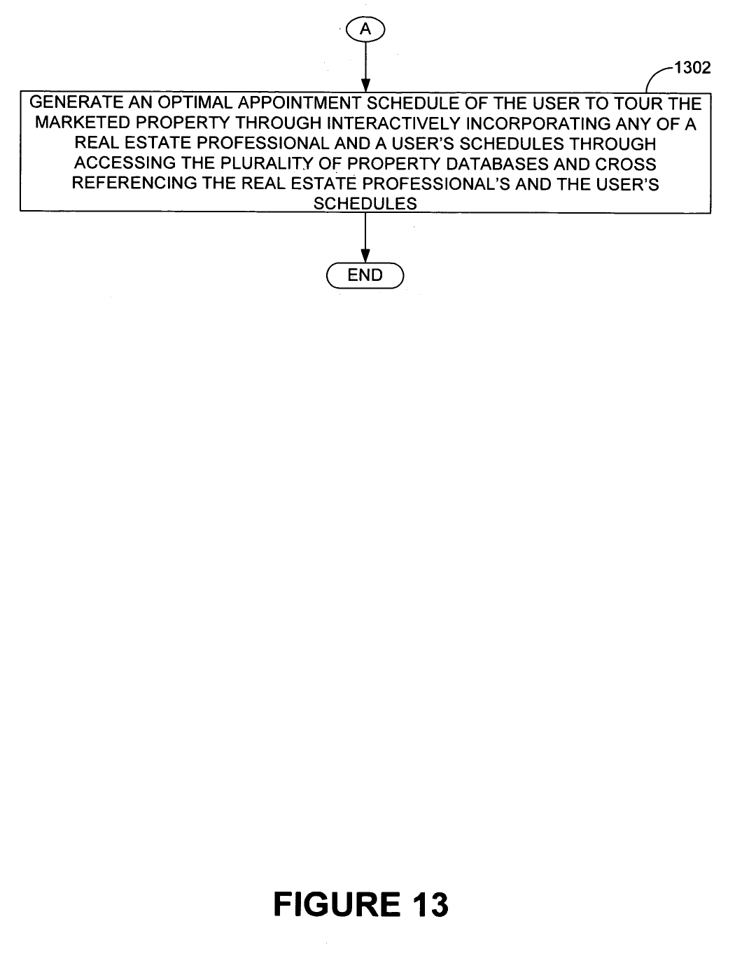

FIG. 13 is a process diagram that describes further the operations of FIG. 12, according to one embodiment. In operation 1302, an optimal appointment schedule of the user (e.g., the user 102 of FIGS. 1, 8) to tour the marketed property may be generated through interactively incorporating any of a real estate professional (e.g., a real estate professional 808 of FIG. 8) and a user's (e.g., the user 102 of FIGS. 1, 8) schedules through accessing the plurality of property databases and cross referencing the real estate professional's (e.g., a real estate professional 808 of FIG. 8) and the user's (e.g., the user 102 of FIGS. 1, 8) schedules.

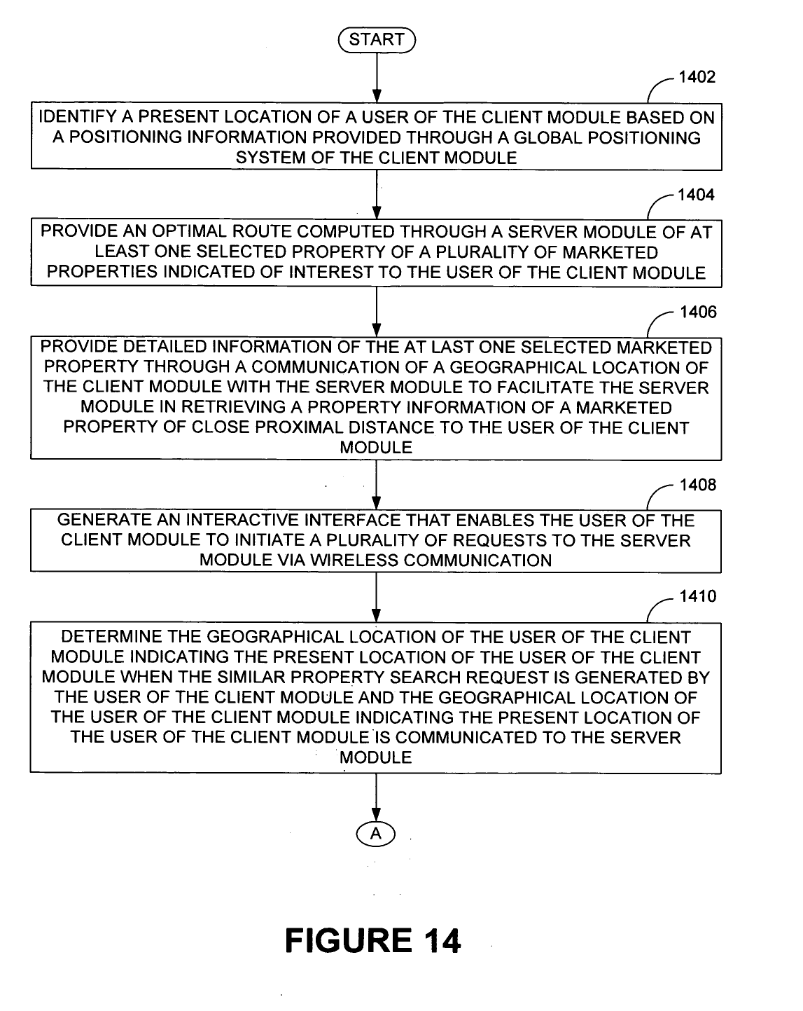

FIG. 14 is a process flow of a server module (e.g., the server module 100 of FIGS. 1, 2), according to one embodiment. In operation 1402, a present location (e.g., the location 510 of FIG. 5) of a user (e.g., the user 102 of FIGS. 1, 8) of the client module (e.g., the client module 106 of FIGS. 1, 4, 6-8) may be identified based on a positioning information provided through a global positioning system of the client module (e.g., the client module 106 of FIGS. 1, 4, 6-8). In operation 1404, an optimal route computed may be provided through a server module (e.g., the server module 100 of FIGS. 1, 2) of at least one selected property of a plurality of marketed properties (e.g., properties 802-808 of FIG. 8) indicated of interest to the user (e.g., the user 102 of FIGS. 1, 8) of the client module (e.g., the client module 106 of FIGS. 1, 4, 6-8).

In operation 1406, detailed information of the at last one selected marketed property may be provided through a communication of a geographical location (e.g., the location 510 of FIG. 5) of the client module with the server module (e.g., the server module 100 of FIGS. 1, 2) to facilitate the server module (e.g., the server module 100 of FIGS. 1, 2) in retrieving a property information of a marketed property of close proximal distance to the user (e.g., the user 102 of FIGS. 1, 8) of the client module (e.g., the client module 106 of FIGS. 1, 4, 6-8). In operation 1408, an interactive interface that enables the user of the client module (e.g., the client module 106 of FIGS. 1, 4, 6-8) may be generated to initiate a plurality of requests to the server module (e.g., the server module 100 of FIGS. 1, 2) via wireless communication. In operation 1410, the geographical location of the user (e.g., the user 102 of FIGS. 1, 8) of the client module (e.g., the client module 106 of FIGS. 1, 4, 6-8) indicating the present location (e.g., the location 510 of FIG. 5) of the user (e.g., the user 102 of FIGS. 1, 8) of the client module (e.g., the client module 106 of FIGS. 1, 4, 6-8) may be determined when the similar property search request is generated by the user (e.g., the user 102 of FIGS. 1, 8) of the client module (e.g., the client module 106 of FIGS. 1, 4, 6-8) and the geographical location (e.g., the location 510 of FIG. 5) of the user (e.g., the user 102 of FIGS. 1, 8) of the client module (e.g., the client module 106 of FIGS. 1, 4, 6-8) indicating the present location of the user (e.g., the user 102 of FIGS. 1, 8) of the client module (e.g., the client module 106 of FIGS. 1, 4, 6-8) is communicated to the server module (e.g., the server module 100 of FIGS. 1, 2).

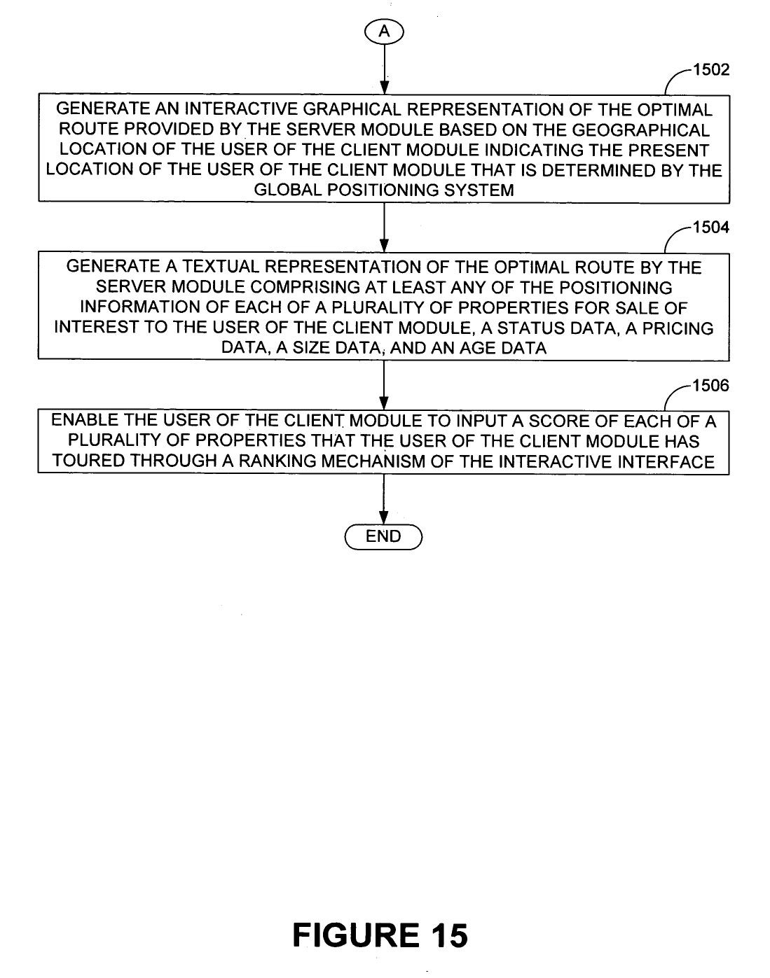

FIG. 15 is a process diagram that describes further the operations of FIG. 14, according to one embodiment. In operation 1502, an interactive graphical representation of the optimal route provided by the server module (e.g., the server module 100 of FIGS. 1, 2) may be generated based on the geographical location (e.g., the location 510 of FIG. 5) of the user (e.g., the user 102 of FIGS. 1, 8) of the client module (e.g., the client module 106 of FIGS. 1, 4, 6-8) indicating the present location (e.g., the location 510 of FIG. 5) of the user (e.g., the user 102 of FIGS. 1, 8) of the client module (e.g., the client module 106 of FIGS. 1, 4, 6-8) that is determined by the global positioning system. In operation 1504, a textual representation of the optimal route may be generated by the server module (e.g., the server module 100 of FIGS. 1, 2) comprising at least any of the positioning information of each of a plurality of properties for sale of interest to the user (e.g., the user 102 of FIGS. 1, 8) of the client module (e.g., the client module 106 of FIGS. 1, 4, 6-8), a status data, a pricing data, a size data, and an age data.

In operation 1506, the user (e.g., the user 102 of FIGS. 1, 8) of the client module (e.g., the client module 106 of FIGS. 1, 4, 6-8) may be enabled to input a score of each of a plurality of properties (e.g., properties 802-808 of FIG. 8) that the user (e.g., the user 102 of FIGS. 1, 8) of the client module (e.g., the client module 106 of FIGS. 1, 4, 6-8) has toured through a ranking mechanism of the interactive interface.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). Similarly, the modules disclosed herein may be enabled using software programming techniques.

For example, the server module 100, the driver module 104, the client module 106, and the passenger module 108 of FIG. 1, the client module positioning module 200, the vehicle positioning module 202, the vehicle scheduling module 204, the geography module 206, the bus scheduler module 208, the ranking generator module 210, the property scoring module 212, the route generator module 214, the appointment module 216, the signature authentication module 218, the search module 220, and the property module 222 of FIG. 2, the global positioning module 600, the map module 602, the data retrieval module 604, the routing module 606, the scheduling module 608, and the home profile module 610 of FIG. 6 may be enabled using transistors, logic gates, and electrical circuits (e.g., application specific integrated ASIC circuitry) such as a server circuit, a driver circuit, a client circuit, and a passenger circuit, a client circuit positioning circuit, a vehicle positioning circuit, a vehicle scheduling circuit, a geography circuit, a bus scheduler circuit, a ranking generator circuit, a property scoring circuit, a route generator circuit, a appointment circuit, a signature authentication circuit, a search circuit, and a property circuit, a global positioning circuit, a map circuit, a data retrieval circuit, a routing circuit, a scheduling circuit, and a home profile circuit.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

1. A method of a server module, comprising:
determining a route of a user to arrive at a set of properties that are indicated of interest to the user through a network based on a geographical location of the user communicated by way of a client module indicating a present location of the user;
optimally adjusting the route of the user to drive by the set of properties computed through a mathematical algorithm having a parameter related to the geographical location of the user communicated via a client module indicating the present location of the user; and
automatically identifying at least one other marketed property proximal to the geographical location of the user communicated via the client module to the server module indicating the present location of the user in addition to a set of marketed properties based on a plurality of property databases.

2. The method of claim 1 further comprising automatically re-adjusting the route of the user to drive by the set of properties when the user deviates from an originally computed route that was based on a previous location of the user.

3. The method of claim 1 further comprising processing the set of marketed properties based on the user interest and the plurality of property databases to compile a meta-data of the set of marketed properties to present the set of marketed properties to the user in an organized format enabling the user to utilize the route in an efficient manner.

4. The method of claim 3 further comprising generating and continuously updating a graphical representation of a plurality of positioning information of the set of marketed properties with respect to a real time geographical location indicating the present location of the user determined through a global positioning system that is wirelessly communicated by the client module to the server module.

5. The method of claim 1 further comprising automatically retrieving property information of the at least one other marketed property proximal to the geographical location indicating the present location of the user determined through a global positioning system and communicated by the client module to the server module.

6. The method of claim 5 further comprising providing a one click access to retrieve information of the at least one other marketed property comprising textual attributes of a pricing data, a size data, an age data, graphical representations having pictures, sketches, architectural blue prints, and a virtual tour of the at least one other marketed property.

7. The method of claim 6 further comprising interactively modifying the route to incorporate directions to the at least one other marketed property through communicating with the plurality of property databases and continuously updating a distance between the geographical location of the user indicating the present location of the user and each marketed property that is indicated of interest of the user.

8. A method of a server module, comprising:
automatically identifying a set of marketed properties that have a plurality of characteristics similar to a particular property having close proximity to a geographical location of a user indicating a present location of the user that is wirelessly communicated by a client module to the server module; and
scheduling an appointment between the user and a real estate professional to expedite a tour of the particular property of the set of marketed properties based on a property information of the particular property automatically retrievable from at least one of a plurality of property databases through a communication between the client module to the server module.

9. The method of claim 8 further comprising processing the plurality of characteristics similar to the particular property and generating an identifier data based on a meta-data of the particular property and identifying another set of marketed properties having a similar set of characteristics based on a correlation of the identifier data.

10. The method of claim 9 further comprising identifying another set of marketed properties having the similar set of characteristics that is located within a particular distance from the geographic location of the user indicating the user's present location through a computation model based on a mathematical algorithm having a parameter that accounts for a distance between the user and each marketed property.

11. The method of claim 10 further comprising incorporating a direction to an another set of marketed properties having the similar set of characteristics to a route to arrive at a marketed properties of interest to the user based on the geographical location indicating the present location of the user.

12. The method of claim 7 further comprising generating an optimal appointment schedule of the user to tour the marketed property through interactively incorporating any of a real estate professional and a user's schedules through accessing the plurality of property databases and cross referencing the real estate professional's and the user's schedules.

13. A method of a client module, comprising:
identifying a present location of a user of the client module based on a positioning information provided through a global positioning system of the client module;
providing an optimal route computed through a server module of at least one selected property of a plurality of marketed properties indicated of interest to the user of the client module;
providing detailed information of the at last one selected marketed property through a communication of a geographical location of the client module with the server module to facilitate the server module in retrieving a property information of a marketed property of close proximal distance to the user of the client module; and
generating an interactive interface that enables the user of the client module to initiate a plurality of requests to the server module via wireless communication.

14. The method of claim 13 wherein the plurality of requests comprise of at least one of the property information retrieval, the optimal route, a similar property search, and an appointment schedule.

15. The method of claim 14 further comprising determining the geographical location of the user of the client module indicating the present location of the user of the client module when the similar property search request is generated by the user of the client module and the geographical location of the user of the client module indicating the present location of the user of the client module is communicated to the server module.

16. The method of claim 13 further comprising generating an interactive graphical representation of the optimal route provided by the server module based on the geographical location of the user of the client module indicating the present location of the user of the client module that is determined by the global positioning system.

17. The method of claim 16 further comprising generating a textual representation of the optimal route by the server module comprising at least any of the positioning information of each of a plurality of properties for sale of interest to the user of the client module, a status data, a pricing data, a size data, and an age data.

18. The method of claim 13 further comprising enabling the user of the client module to input a score of each of a plurality of properties that the user of the client module has toured through a ranking mechanism of the interactive interface.

19. The method of claim 13 wherein the interactive interface further enables the user of the client module to request a viewing of any of a pictorial representation and a video representation data of the plurality of marketing properties for sale communicated to the client module by the server module.

20. A system, comprising:
a client module operated by a property shopper to determine a geographical location of the property shopper based on a positioning information provided through a global positioning system of the client module communicated to a server module through a network and wherein the client module includes a one click module of the client module to automatically identify at least one marketed property proximal to the geographical location of the property shopper and to retrieve property information of the at least one marketed property proximal to the geographical location of the property shopper; and
the server module to process the geographical location that determines the current location of the property shopper, to generate an optimally efficient route, to inspect a plurality of marketed properties, to communicate the optimally efficient route to the client module through the network, and to streamline a property shopping process of the property shopper.

21. The system of claim 20 wherein the server module to automatically re-adjust a route when the property shopper deviates from an initially computed routed that was based on a previous location of the property shopper.

22. The system of claim 20 wherein the server module to process the plurality of marketed properties based on property shopper interest and a plurality of property databases to compile a meta-data of the plurality of marketed properties to present the plurality of marketed properties to the property shopper in an organized format enabling the property shopper to utilize a route in an efficient manner.

23. The system of claim 20 wherein the server module to automatically identify the at least one other marketed property proximal to the geographical location of the user communicated via the client module to the server module indicating the present location of the user in addition to a set of marketed properties based on a plurality of property databases.
